(19) United States
(12) Patent Application Publication
(10) Pub. No.: US 2008/0292296 A1
(43) Pub. Date: Nov. 27, 2008

(54) Vibration compensation for image capturing device

(76) Inventors: Jae Wook Ryu, Ansan-si (KR); Young Pyo Lee, Ansan-si (KR); Joung Suk Ko, Ansan-si (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/802,791

(22) Filed: May 25, 2007

(51) Int. Cl. G03B 17/00; H04N 5/00

(52) U.S. Cl. 396/55; 348/208.4

(57) ABSTRACT

Disclosed herein is an apparatus for compensating for vibration of an image capturing device. The apparatus includes a y-axis stage installed in a support structure so as to be movable in y-axis direction. An x-axis stage is installed on the y-axis stage so as to be movable in x-axis direction on an xy plane. An image sensor is mounted on the x-axis stage. The apparatus is provided with a y-axis driver and an x-axis driver for driving the y-axis stage in the y-axis direction and the x-axis stage in the x-axis direction respectively. A control unit is installed in the image capturing device. The control unit operates to sense vibration of the image capturing device through a separate vibration sensor and to drive the y-axis driver and the x-axis driver to vibrate the image sensor in a way to compensate for the vibration of image capturing device.

### FIELD OF THE INVENTION

The present invention relates to an apparatus for compensating for vibration of an image capturing device, more specifically to such an apparatus for moving an image sensor in a way as to correct vibration by an unsteady hand to thereby prevent image blurring.

### BACKGROUND OF THE INVENTION

In general, cellular phones capable of transmitting mobile images, image capturing devices such as digital cameras and camcorders, and the like are manufactured in compact and lightweight designs for the convenience of portability. These small-sized image capturing devices have functions of capturing images, and recording and reproducing the captured images, and have been widely popularized in recent years.

Typically, such small image capturing devices are portable and often cause blurred images due to inevitable hand-shaking. Although different people have different degrees of hand-shaking, it consequently leads to a blurred image, due to unsteady focal point. When the blurred image is projected onto a large screen, the projected image comes to have degraded resolution and chromatism, i.e., failing to have quality image.

In order to solve these problems, conventionally electrical or mechanical approaches have been attempted in order to compensate for the unsteady hand or hand-shaking when in use of the image capturing device. That is, as an electrical compensating apparatus, an image signal is sampled from the charge coupled device and analyzed to determine the vibration by hand-shaking and then correct the image. As another approach, the vibration may be detected by means of an angle sensor and then the image being captured by the image capturing device is compensated corresponding to the hand-shaking direction.

Further, the mechanical approach senses vibration of an image capturing device and the lens is driven in opposite direction to the movement of the device. Alternatively, shaking of the image capturing device is detected and then the optical axis of the acti-prism, which is placed in front of the device, is corrected.

However, the above electrical control has disadvantages of degraded resolution of image and narrow compensation range. The mechanical approach must use a motor for driving the lens and the entire image capturing device, leading to a higher consumption of power and an obstacle to realization of compact and lightweight products. Since light is refracted by acti-prism, it is resolved according to the wavelength of light, thereby incurring chromatic aberration.

### SUMMARY OF THE INVENTION

The present invention has been made in order to solve at least part of the problems in the art. It is an object of the invention to provide a simplified mechanical apparatus for moving the image sensor in a direction as to compensate for the vibration by hand-shaking, thereby resulting in quality image and reduced power consumption, and compact and lightweight image capturing devices.

In order to accomplish the above objects, according to one aspect of the invention, there is provided an apparatus for compensating for vibration of an image capturing device. The apparatus includes a y-axis stage is installed in a support structure so as to be movable in y-axis direction, a y-axis driver for driving the y-axis stage in the y-axis direction, an x-axis stage installed on the y-axis stage so as to be movable in x-axis direction, and an x-axis driver for driving the x-axis stage in the x-axis direction. An image sensor can be mounted on the x-axis stage. The image capturing device has a control unit, which operates to sense vibration of the image capturing device using a separate vibration sensor and to drive the y-axis driver and the x-axis driver to vibrate the image sensor in a way to compensate for the vibration of image capturing device.

In an embodiment, the y-axis stage is disposed at one side of the support structure and the x-axis is disposed at the other side of the support structure.

In an embodiment, the apparatus includes a first spring member for urging the y-axis stage towards the initial position thereof, and a second spring member for urging the x-axis stage towards the initial position thereof.

According to another aspect of the invention, there is provided an apparatus for compensating for vibration of an image capturing device. The apparatus comprises a stage installed in a support structure by means of a resilient member so as to be movable in a first direction and a second direction, a first driver for driving the stage in the first direction, and a second driver for driving the stage in the second direction. The first and second directions are substantially perpendicular to each other. An image sensor can be mounted on the stage. A control unit is provided for controlling the first and second drivers in a way to compensate for the vibration of image capturing device.

According to another aspect of the invention, there is provided a vibration compensator for an image capturing device. A first stage is installed in a support structure by means of a first resilient member so as to be movable in a first direction. A second stage is installed on the first stage by means of a second resilient member so as to be movable in a second direction. An image sensor can be mounted on the second stage. A first driver and a second driver are provided for driving the first and second stages along the first and second directions respectively. Here, the first and second directions are substantially perpendicular to each other. A control unit is provided for controlling the first and second drivers in a way to compensate for the vibration of image capturing device.

### BRIEF DESCRIPTION OF THE DRAWINGS

Further objects and advantages of the invention can be more fully understood from the following detailed description taken in conjunction with the accompanying drawings in which:

FIG. 1 is an exploded perspective view of a camera vibration compensator according to an embodiment of the invention;

FIG. 2 shows the camera vibration compensator of FIG. 1 when assembled;

FIG. 3 is a sectional view taken along the x-axis in the camera vibration compensator of FIG. 2;

FIG. 4 is a sectional view taken along the y-axis in the camera vibration compensator of FIG. 2;

FIG. 5 is an exploded perspective view of a vibration compensator according to another embodiment of the invention;

FIG. 6 shows the vibration compensator of FIG. 5 when assembled;

FIG. 7 is a sectional view taken along the x-axis in the vibration compensator of FIG. 5;

FIG. 8 is a sectional view taken along the y-axis in the vibration compensator of FIG. 5;

FIG. 9 is an exploded perspective view of a vibration compensator according to yet another embodiment of the invention;

FIG. 10 shows the vibration compensator of FIG. 9 when assembled;

FIG. 11 is a sectional view taken along the x-axis in the vibration compensator of FIG. 9; and

FIG. 12 is a sectional view taken along the y-axis in the vibration compensator of FIG. 9.

### DETAILED DESCRIPTION OF THE EXEMPLARY EMBODIMENTS OF THE INVENTION

Hereafter, exemplary embodiments of the invention will be explained, with reference to the accompanying drawings.

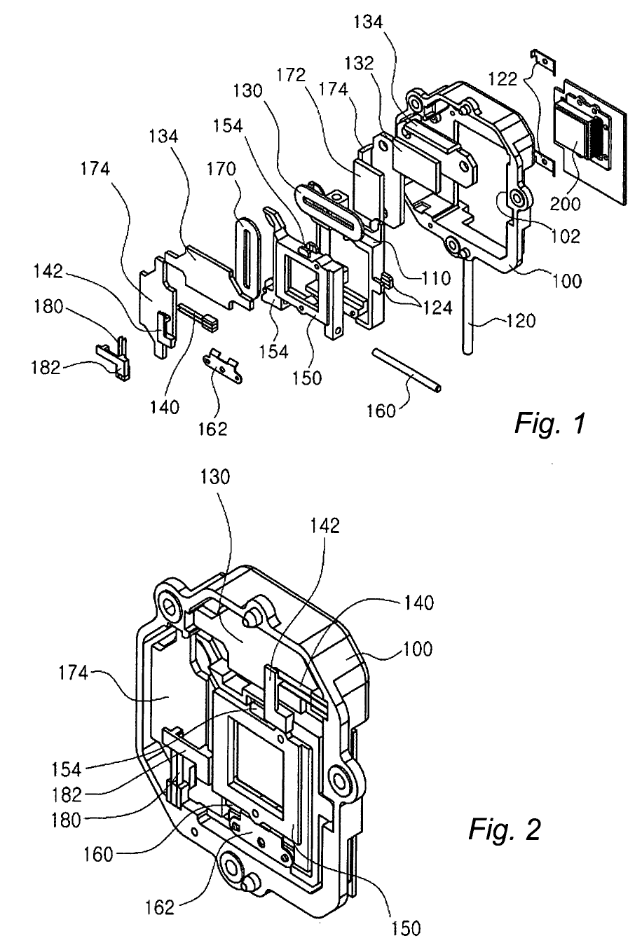

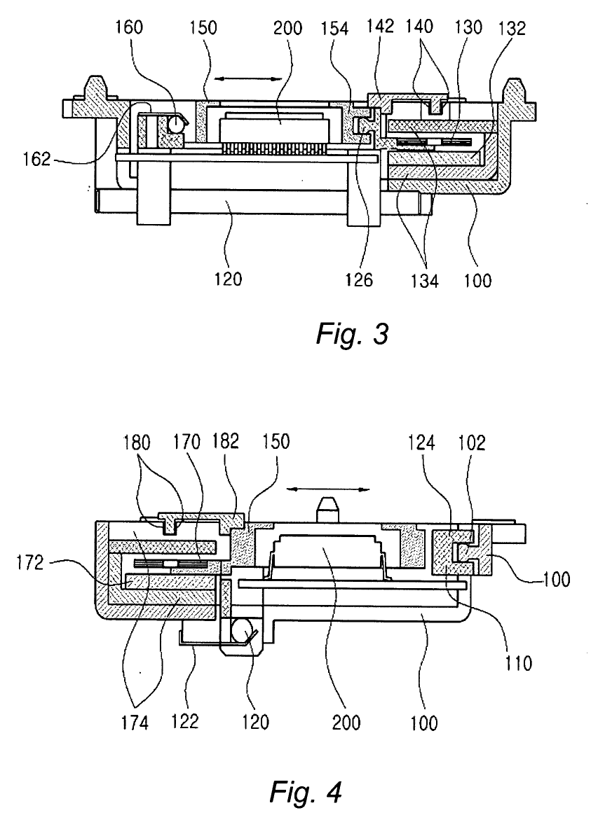

FIG. 1 is an exploded perspective view of a camera vibration compensator according to a first embodiment of the invention. FIG. 2 shows the camera vibration compensator of FIG. 1 when assembled. FIG. 3 is a sectional view taken along the x-axis in the camera vibration compensator of FIG. 2. FIG. 4 is a sectional view taken along the y-axis in the camera vibration compensator of FIG. 2.

In this embodiment, the vibration compensator includes a base 100 that is to be fixed on an image capturing device such as a digital camera, a y-axis stage 110 installed in the base 100 so as to be movable in y-direction, and a y-axis driver for driving the y-axis stage 110 in the y-direction. Here, the base 100 can be replaced by any desired structural support. An x-axis stage 150 is installed on the y-axis stage 110 so as to be movable in the x-direction on the x, y-plane. An image sensor 200 is mounted on the x-axis stage 150. Alternatively, the image sensor 200 may be mounted on the y-axis stage 110. An x-axis driver is provided for driving the x-axis stage in the x-direction. A control unit is installed in the digital camera. The control unit serves to sense vibration of the digital camera using a separate vibration sensor, and drive the y-axis driver and the x-axis driver to vibrate the image sensor 200 such that the vibration of digital camera can be compensated for.

Here, the digital camera is presented for illustrative purposes. The present invention can be applied to various types of image capturing devices such as camcorders.

A y-axis shaft 120 is fixed at one side of the y-axis stage 110 along the y-direction and a second guide rib 124 is formed at the other side of y-axis stage 110 in parallel to the y-axis shaft 120. Fixed at one side of the base 100 is a y-axis holder 122, which is slidably combined with the y-axis shaft 120. Formed at the other side of the base 100 is a first guide rib 102 that is slidably engaged with the second guide rib 124.

One side of the y-axis stage 110 is supported through the y-axis shaft 120 and the other side thereof is supported through engagement of the first and second guide ribs 102 and 124. This is because, although the y-axis shaft 120 and the y-axis holder 122 are solidly combined, but they incurs a frictional force. Thus, in order to reduce the frictional force, one side thereof is combined through the first and second guide ribs 102 and 124.

The y-axis driver is composed of a first magnet 132 fixed to the base 100, and a first coil 130 fixed to the y-axis stage 110. The first coil 130 has multiple windings and is disposed within the electromagnetic field of the first magnet 132. When electric current is applied to the first coil, the first coil generates an electromagnetic force that interacts with magnetic flux of the first magnet 132 to drive the y-axis stage 110 in the y-direction. Alternatively, the first magnet 132 may be fixed to the y-axis stage 110 and the first coil 130 is fixed to the base 100 in order to obtain substantially the same results.

In addition, the y-axis driver is provided with a first yoke 134 for concentrating magnetic flux of the first magnet 132 towards the first coil 130 and returning the magnet flux passing the first coil 130 back to the first magnet 132.

An x-axis shaft 160 is fixed to the x-axis stage 150 along the x-direction, and a fourth guide rib 154 is formed in parallel to the x-axis shaft 160. Fixed to one side of the y-axis stage 110 is an x-axis holder 162 that is slidably combined with the x-axis shaft 160. Formed at the other side of the y-axis stage is a third guide rib 126 that is slidably engaged with the fourth guide rib 154.

The x-axis driver is composed of a second magnet 172 fixed to the base 100, and a second coil 170 fixed to the x-axis stage 150. Similar to the y-axis driver, the second magnet 172 may be fixed to the x-axis stage 150, and the second coil 170 may be fixed to the base 100. The second coil 170 has multiple windings and is disposed within the electromagnetic field of the second magnet 172. When electric current is applied to the second coil, the second coil 170 generates an electromagnetic force that interacts with magnetic flux of the second magnet 172 to drive the x-axis stage 150 in the x-direction.

In addition, the x-axis driver is provided with a second yoke 174 for concentrating magnetic flux of the second magnet 172 towards the second coil 170 and returning the magnet flux passing the second coil 170 to the second magnet 172.

On the other hand, a first spring member is fixed to the base 100. The first spring member functions to exert a force on the y-axis stage to restore it into the initial position. The first spring member is constituted of a first leaf spring 140 that generates a resistant force against movement of the y-axis stage 110.

The first leaf spring 140 is formed of a pair of parallel first leaf springs 140. A first bracket 142 is fixed to the y-axis stage 110. The first bracket 142 has a protrusion that is inserted between the pair of first leaf springs 140.

In addition, a second spring member is fixed to the base 100. The second spring member functions to exert a force on the x-axis stage 150 to restore it into the initial position. The second spring member is constituted of a second leaf spring 180 that generates a resistant force against movement of the x-axis stage 150.

The second leaf spring 180 is formed of a pair of parallel second leaf springs 180. A second bracket 182 is fixed to the x-axis stage 150. The second bracket 182 has a protrusion that is inserted between the pair of second leaf springs 180.

Hereafter, operation of the above vibration compensator apparatus for image-capturing devices will be described.

When the digital camera is off, the y-axis stage 110 and the x-axis stage 150 remain at their initial position due to resilient forces of the first and second leaf springs 140 and 180 respectively. Even though the digital camera vibrates or is shaken, the y-axis stage 110 and the x-axis stage 150 always come to be restored into their initial position, due to elastic force of the first and second leaf springs 140 and 180 respectively.

Thus, the control unit can rapidly recognize initial positions of the image sensor.

On the other hand, a separate vibration sensor detects vibration of the digital camera and transmits the results to the control unit. Then the control unit drives the x-axis driver and the y-axis driver such that the image sensor 200 is vibrated so as to compensate for the vibration of the digital camera, thereby preventing vibration (blurring) of the image being captured by the image sensor 200.

More specifically, if the control unit applies electric current to the first coil 130, magnetic flux from the first magnet 132 passes through the first coil 130. Interaction between the magnetic flux and the first coil 130 generates an electromagnetic force capable of moving the y-axis stage 110 along the y-direction. This electromagnetic force causes the y-axis stage 110 to move along the y-direction in a fine and precise manner such that y-axis vibration of the digital camera can be compensated for or corrected.

During this course of action, the first yoke 134 operates such that magnetic flux of the first magnet 132 passes through the first coil and is returned to the first magnet 132 in an efficient way.

Simultaneously, if the control unit applies electric current to the second coil 170, magnetic flux from the second magnet 172 passes through the second coil 170. Interaction between the magnetic flux and the second coil 170 generates an electromagnetic force capable of moving the x-axis stage 150 along the x-direction. This electromagnetic force causes the x-axis stage 150 to move along the x-direction in a fine and precise manner such that x-axis vibration of the digital camera can be compensated for or corrected.

During this course of action, the second yoke 174 operates such that magnetic flux of the second magnet 172 passes through the second coil 170 and is returned to the second magnet 172 in an efficient way.

In addition, the driving force of the y-axis driver and the x-axis driver is configured to be larger than the elastic resistance of the first and second leaf springs 140 and 180 respectively.

In this way, the image sensor 200 is driven so as to compensate for vibration of the digital camera, and thus to correct vibration (blurring) of the image being captured in the image sensor 200.

On the other hand, if the driving force is removed from the y-axis driver and x-axis driver, the y-axis stage 110 and the x-axis stage 150 are restored into their initial position due to the elastic force of the first and second leaf springs 140 and 180.

Hereafter, another embodiment of the invention is explained, with reference to the accompanying drawings.

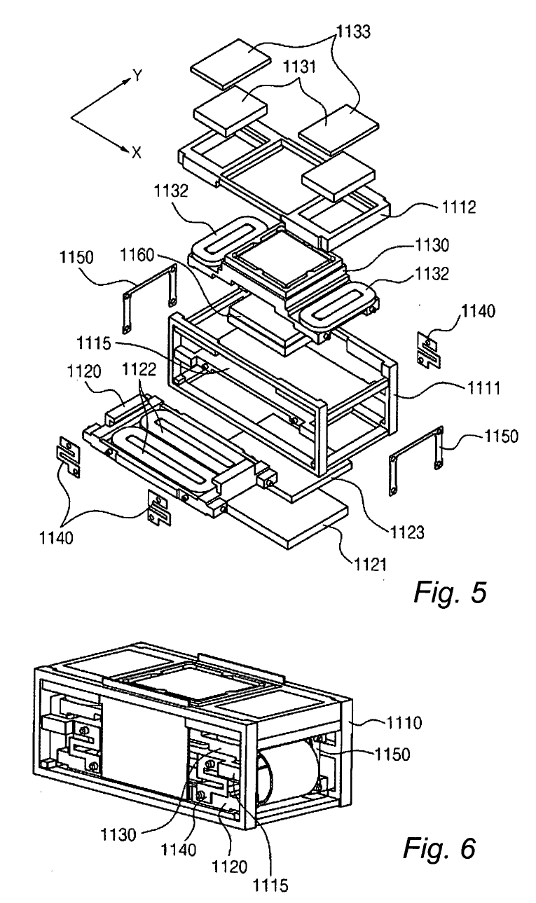

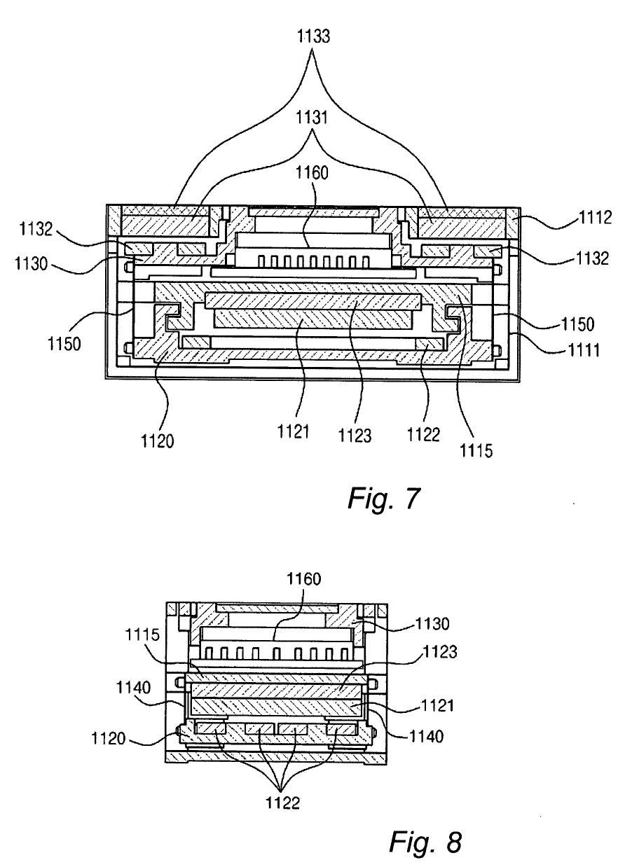

FIG. 5 is an exploded perspective view of a vibration compensator according to another embodiment of the invention. FIG. 6 shows the vibration compensator of FIG. 5 when assembled. FIG. 7 is a sectional view taken along the x-axis in the vibration compensator of FIG. 5. FIG. 8 is a sectional view taken along the y-axis in the vibration compensator of FIG. 5.

Referring to FIGS. 5 to 8, the vibration compensator of this embodiment includes a housing 1110, stages 1120 and 1130, a driver, a control unit (not shown), spring members 1150 and 1160, and the like.

The housing 1110 is made of a main body 1111 and a cover 1112 combined to each other. Formed at the central area of the housing 1110 is a support member 1115 in parallel to the stages 1120 and 1130 and for guiding movement of the stages 1120 and 1130.

The stages 1120 and 1130 is constituted of an x-axis stage 1130 installed to be capable of moving in the x-direction and a y-axis stage 1120 installed so as to be movable in the y-direction on the xy-plane. Here, the x-direction and y-direction are perpendicular to each other. Both x-axis and y-axis stages are housed in the housing 1110. An image sensor 1160 is mounted on the x-axis stage 1130.

The driver includes an x-axis driver for driving the x-axis stage 1130 in the x-direction and a y-axis driver for driving the y-axis stage 1120 in the y-direction.

The y-axis driver is composed of a first magnet 1121 fixed to the housing 1110, and a first coil 1122 fixed to the y-axis stage 1120. It should be understood that the first magnet may be fixed to the y-axis stage and the first coil to the housing. The first coil 1122 has multiple windings and is disposed within the electromagnetic field of the first magnet 1121. When electric current is applied to the first coil, the first coil generates an electromagnetic force that interacts with magnetic flux of the first magnet 1121 to drive the y-axis stage 1120 in the y-direction. In addition, the y-axis driver includes a first yoke 1123 for concentrating magnetic flux of the first magnet 1121 towards the first coil 1122 and returning the magnet flux passing the first coil 1122 to the first magnet 1121.

The x-axis driver is composed of a second magnet 1131 fixed to the housing 1110, and a second coil 1132 fixed to the x-axis stage 1130. Similarly, the second magnet may be fixed to the x-axis stage and the second coil to the housing. The second coil 1132 has multiple windings and is disposed within the electromagnetic field of the second magnet 1131. When electric current is applied to the second coil, the second coil generates an electromagnetic force that interacts with magnetic flux of the second magnet 1131 to drive the x-axis stage 1130 in the x-direction. In addition, the x-axis driver includes a second yoke 1133 for concentrating magnetic flux of the second magnet 1131 towards the second coil 1132 and returning the magnet flux passing the second coil 1132 to the second magnet 1131.

The control unit controls the drivers in such a way to sense vibration of the digital camera from a vibration sensor (not shown) and to vibrate the image sensor 1160 in a manner so as to compensate for the vibration of camera.

The spring member 1150 and 1140 serves to fix and support the stages 1120 and 1130 to the housing 1110.

The spring member 1150, 1140 is composed of a y-axis spring member 1140 for connecting and supporting the y-axis stage 1120 to the housing 1110, and an x-axis spring member 1150 for connecting and supporting the x-axis stage 1130 to the y-axis stage 1120.

That is, the y-axis stage 1120 is coupled to the support member 1115 from under the support member 1115 by means of they-axis spring member 1140. The x-axis stage 1130 is coupled to the y-axis stage 1120 from above the support member 1115 by means of the x-axis spring member 1150.

As described above, the stages 1120 and 1130 are fixed to and supported on the housing 1110 through the spring members 1150 and 1160. Thus, due to the elastic force of the spring members, the stages are urged towards their initial positions. In addition, since the stages 1120 and 1130 are supported through the spring members 1150 and 1140 only, no substantial frictional force occurs during movement of the stages 1120 and 1130, thereby enabling to move the stages with a reduced energy.

At this time, the support member 1115, the x-axis stage 1130 and the y-axis stage are formed with a rib respectively, through which the x-axis stage and y-axis stage can slidably move along the support member 1115.

The spring member 1150, 1140 is formed of a leaf spring, for example such that a pair of leaf springs is installed so as to face each other, as shown in FIG. 5. Two or more leaf springs may be installed, when necessary.

More specifically, the y-axis spring members 1140 are mounted so as to face each other on the y-axis, and the x-axis spring members 1150 are mounted so as to face each other on the x-axis. Thus, the elastic restoring force of the spring members acts along the x-axis and the y-axis respectively.

At this time, the x-axis spring member 1150 is formed of a straight leaf spring that connects the x-axis stage 1130 with the y-axis stage 1120. The y-axis spring member 1140 is formed of an angularly-bent leaf spring that connects the y-axis stage to the support member 1115.

This is because the y-axis spring member 1140 is short than the x-axis spring member 1150. That is, if the x-axis spring member 1150 and the y-axis spring member 1140 are formed in an identical shape, the y-axis spring member 1140 causes relatively less elastic deformation, consequently which results in relatively less amount of movement along the y-axis direction. In addition, a larger amount of energy is required for moving the y-axis stage 1120.

Therefore, the y-axis spring member 1140 is formed of an angularly-bent leaf spring that can provide a larger amount of elastic deformation rather than a straight leaf spring, i.e., such that the y-axis stage and the x-axis stage can move in a substantially same elastic behavioral mode. In addition, the larger amount of elastic deformation of the y-axis spring member 1140 leads to a less amount of energy to move the y-axis stage 1120.

Hereafter, operation of the above vibration compensator will be explained.

Where the digital camera is off, the y-axis stage 1120 and the x-axis stage remain at their initial positions, due to elastic force of the y-axis spring member 1140 and the x-axis spring member 1150 respectively.

Even in case where the digital camera is shaken, the y-axis stage 1120 and the x-axis stage 1130 are always restored into their original positions, due to the resiliency of the y-axis spring member 1140 and the x-axis spring member 1150 respectively.

Thus, the control unit can rapidly recognize initial position of the image sensor 1160.

On the other hand, a separate vibration sensor detects vibration of the digital camera and transmits the detection to the control unit. The control unit drives the y-axis driver and the x-axis drive to move the y-axis stage 1120 and the x-axis stage 1130 where the image sensor 1160 is mounted, such that the vibration of the digital camera can be compensated for. Thus, image being captured by the image sensor 1160 can be prevented from vibrating, i.e. prevent image-blurring.

For doing this, first the control unit applies electric current to the first coil 1122. Then, magnetic flux from the first magnet 1121 passes through the first coil 1122. Interaction between the magnetic flux and the first coil 1122 generates an electromagnetic force in the first coil 1122 to move the y-axis stage 1120 along the y-direction.

By means of this electromagnetic force, the y-axis stage 1120 moves in a fine and precise way along the y-direction against the elastic force of the y-axis spring member 1140. That is, the y-axis stage 1120 moves along the y-axis so as to compensate for y-axis vibration of the digital camera, thereby correcting the y-axis vibration.

During this course of action, the first yoke 1123 operates such that magnetic flux of the first magnet 1121 passes through the first coil 1122 and is returned to the first magnet 1121 in an efficient way.

Simultaneously, the control unit applies electric current to the second coil 1132. Then, magnetic flux from the second magnet 1131 passes through the second coil 1132. Interaction between the magnetic flux and the second coil 1132 generates an electromagnetic force in the second coil 1132 to move the x-axis stage 1130 along the x-direction.

By means of this electromagnetic force, the x-axis stage 1130 moves in a fine and precise way along the x-direction against the elastic force of the x-axis spring member 1150. That is, the x-axis stage 1130 moves along the x-axis so as to compensate for x-axis vibration of the digital camera, thereby correcting the x-axis vibration.

During this course of action, the second yoke 1133 operates such that magnetic flux of the second magnet 1131 passes through the second coil 1132 and is returned to the second magnet 1131 in an efficient way.

In addition, the driving force of the y-axis driver and the x-axis driver is configured to be larger than the elastic resistance of the y-axis spring member 1140 and the x-axis spring member 1150.

Here, since the stages 1120 and 1130 are connected only through the spring members 1150 and 1140, no substantial frictional force occurs during movement of the stages 1120 and 1130, thereby enabling to move the stages with reduced energy.

In this way, the image sensor 1160 is driven in a way as to compensate for vibration of the digital camera, thus correcting vibration (blurring) of the image being captured in the image sensor 1160.

On the other hand, if the driving force is removed from the y-axis driver and x-axis driver, the y-axis stage 1120 and the x-axis stage 1130 are restored into their initial position due to the elastic force of the y-axis spring member 1140 and the x-axis spring member 1150.

Hereafter, yet another embodiment of the invention is explained, with reference to the accompanying drawings.

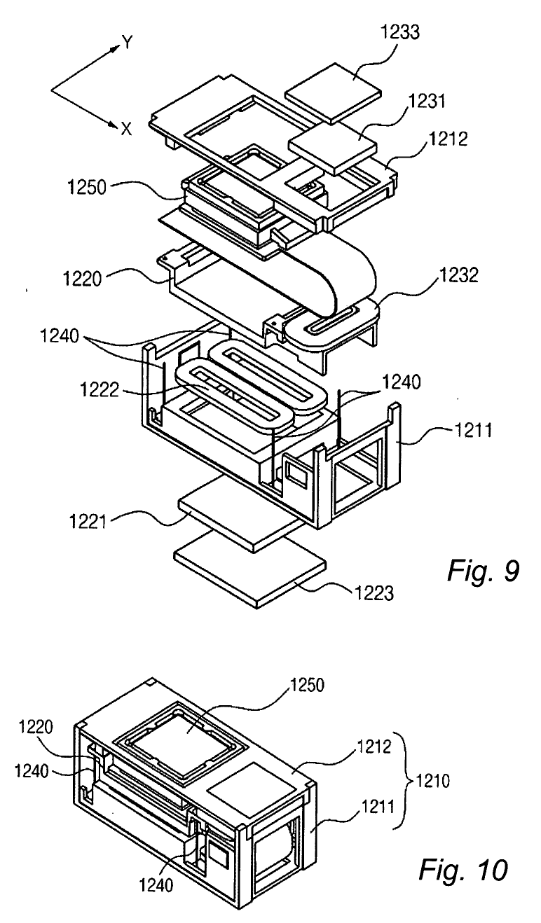

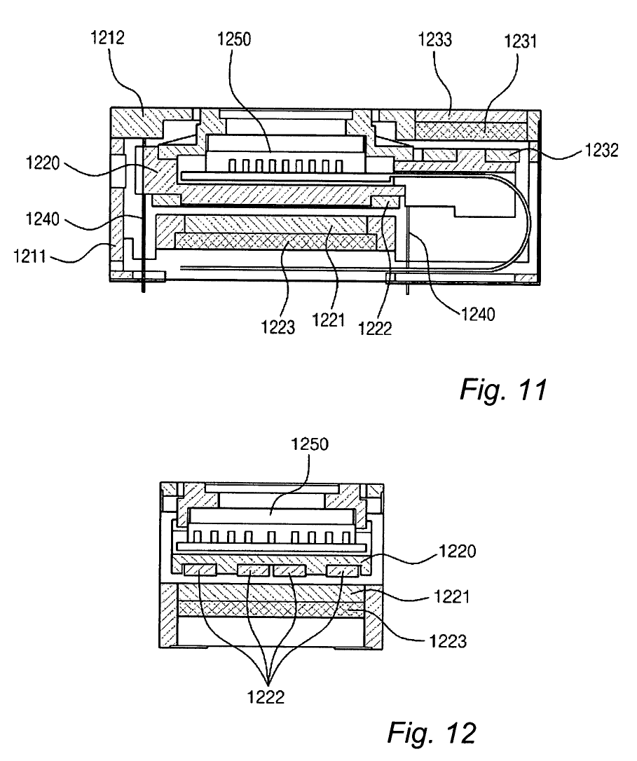

FIG. 9 is an exploded perspective view of a vibration compensator according to yet another embodiment of the invention. FIG. 10 shows the vibration compensator of FIG. 9 when assembled. FIG. 11 is a sectional view taken along the x-axis in the vibration compensator of FIG. 9. FIG. 12 is a sectional view taken along the y-axis in the vibration compensator of FIG. 9.

Referring to FIGS. 9 to 12, the vibration compensator of this embodiment includes a housing 1210, a stage 1220, a driver, a control unit (not shown), a spring member, and the like.

The housing 1210 is made of a main body 1211 and a cover 1212 combined to each other.

Dissimilar to the above second embodiment, the stage 1220 is formed of a single stage and disposed inside of the housing 1210. An image sensor 1250 is mounted on the stage 1220.

The driver includes an x-axis driver for driving the stage 1220 in the x-direction and a y-axis driver for driving the stage 1120 in the y-direction.

The y-axis driver is composed of a first magnet 1221 fixed to the housing 1110, and a first coil 1222 fixed to the stage 1220. Here, it should be understood that the first magnet may be fixed to the stage and the first coil to the housing. The first coil 1222 has multiple windings and is disposed within the electromagnetic field of the first magnet 1221. When electric current is applied to the first coil, the first coil generates an electromagnetic force that interacts with magnetic flux of the first magnet 1221 to drive the stage 1220 in the y-direction. In addition, the y-axis driver includes a first yoke 1223 for concentrating magnetic flux of the first magnet 1221 towards the first coil 1222 and returning the magnet flux passing the first coil 1222 to the first magnet 1221.

The x-axis driver is composed of a second magnet 1231 fixed to the housing 1210, and a second coil 1232 fixed to the stage 1220. Similarly, the second magnet may be fixed to the stage and the second coil to the stage. The second coil 1232 has multiple windings and is disposed within the electromagnetic field of the second magnet 1231. When electric current is applied to the second coil, the second coil generates an electromagnetic force that interacts with magnetic flux of the second magnet 1231 to drive the stage 1220 in the x-direction. In addition, the x-axis driver includes a second yoke 1233 for concentrating magnetic flux of the second magnet 1231 towards the second coil 1232 and returning the magnet flux passing the second coil 1232 to the second magnet 1231.

The control unit controls the drivers in such a way to sense vibration of the digital camera from a vibration sensor and vibrate the image sensor 1250 so as to compensate for the vibration of camera.

The spring member serves to fix and support the stage 1220 to the housing 1210.

The spring member is constituted of a wire spring 1240, one end of which is attached to the housing 1210 and the other end of which is attached to the stage 1220.

Here, three or more wire springs are installed to support the stage 1220 in more stable way.

In this embodiment, as shown in FIG. 9, four wire springs are provided, which are installed at the corners of the stage. That is, the stage 1220 is supported by means of the wire springs 1240 so as to be floated inside of the housing 1210.

Of course, the wire spring 1240 has a mechanical strength enough to support the stage 1220.

In addition, the wire spring 1240 may be disposed between the housing 1210 and the bottom of the stage 1220 to connect them to each other, or alternatively disposed between the housing 1210 and the top of the stage 1220.

In case where multiple wire springs 1240 are mounted, preferably they are configured to provide substantially the same elasticity in the x-axis and y-axis directions.

As above, the stage 1220 is fixed to and supported on the housing 1210 through a spring member formed of the wire spring 1240. Thus, due to the elastic force of the spring member, the stage is always biased towards its initial position. In addition, since the stage 1220 is supported through only the wire spring member, no substantial frictional force occurs during movement of the stage 1220, thereby enabling to move the stages with reduced energy.

Further, since a single stage 1240 (where an image sensor 1250 is mounted) is moved in both x-direction and y-direction by means of the wire spring 1240, the number of parts can be reduced to enable cost-down and miniaturization of the products.

At this time, the housing 1210 and the stage 1220 are formed with a rib respectively, through which the stage 1220 can slidably move along the housing 1210.

Hereafter, operation of the above vibration compensator will be explained.

When the digital camera is off, the stage 1220 remains at the initial position thereof due to elastic force of the wire spring 1240.

Even in case where the digital camera is shaken, the stage 1220 is always restored into its original position, due to the resiliency of the wire spring 1240.

Thus, the control unit can rapidly recognize initial position of the image sensor 1250.

On the other hand, a separate vibration sensor detects vibration of the digital camera and transmits the detection to the control unit. The control unit drives the y-axis driver and the x-axis drive to move the stage 1220 where the image sensor 1250 is mounted, such that the vibration of the digital camera can be compensated for. Thus, image being captured by the image sensor 1250 can be prevented from vibrating, i.e., image-blurring.

For doing this, first the control unit applies electric current to the first coil 1222. Then, magnetic flux from the first magnet 1221 passes through the first coil 1222. Interaction between the magnetic flux and the first coil 1222 generates an electromagnetic force in the first coil 1222 to move the stage 1220 along the y-direction.

By means of this electromagnetic force, the stage 1220 moves in a fine and precise way along the y-direction against the elastic force of the wire spring 1240. That is, the stage 1220 moves along the y-axis so as to compensate for y-axis vibration of the digital camera, thereby correcting the y-axis vibration.

During this course of action, the first yoke 1223 operates such that magnetic flux of the first magnet 1221 passes through the first coil 1222 and is returned to the first magnet 1221 in an efficient way.

Simultaneously, the control unit applies electric current to the second coil 1232. Then, magnetic flux from the second magnet 1231 passes through the second coil 1232. Interaction between the magnetic flux and the second coil 1232 generates an electromagnetic force in the second coil 1232 to move the stage 1220 along the x-direction.

By means of this electromagnetic force, the stage 1220 moves in a fine and precise way along the x-direction against the elastic force of the wire spring 1240. That is, the stage 1220 moves along the x-axis so as to compensate for x-axis vibration of the digital camera, thereby correcting the x-axis vibration.

During this course of action, the second yoke 1233 operates such that magnetic flux of the second magnet 1231 passes through the second coil 1232 and is returned to the second magnet 1231 in an efficient way.

In addition, the driving force of the y-axis driver and the x-axis driver is configured to be larger than the elastic resistance of the wire spring 1240.

Here, since the stage is connected by means of the wire spring 1240 only, no substantial frictional force occurs during movement of the stage 1220, thereby enabling to move the stages with reduced energy.

In this way, the image sensor 1250 is driven in a way as to compensate for vibration of the digital camera, thus correcting vibration (blurring) of the image being captured in the image sensor 1250.

On the other hand, if the driving force is removed from the y-axis driver and x-axis driver, the stage 1220 is restored into its initial position due to the elastic force of the wire spring 1240.

As described above, the vibration compensator according to the invention can be mounted in an image capturing device such as digital camera. It operates to move the image sensor in a way as to compensate for vibration being transferred to the image capturing device.

Although the present invention has been described with reference to several exemplary embodiments, the description is illustrative of the invention and is not to be construed as limiting the invention. Various modifications and variations may occur to those skilled in the art, without departing from the spirit and scope of the invention, as defined by the appended claims.

What is claimed is:

1. An apparatus for compensating for vibration of an image capturing device, the apparatus comprising:
a y-axis stage installed in a support structure so as to be movable in y-axis direction;
a y-axis driver for driving the y-axis stage in the y-axis direction;
an x-axis stage installed on the y-axis stage so as to be movable in x-axis direction, an image sensor being able to be mounted on the x-axis stage;
an x-axis driver for driving the x-axis stage in the x-axis direction; and
a control unit operating to sense vibration of the image capturing device through a separate vibration sensor and to drive the y-axis driver and the x-axis driver to vibrate the image sensor in a way to compensate for the vibration of image capturing device.

2. The apparatus as claimed in claim 1, wherein a y-axis shaft is fixed in the y-axis direction to one side of the y-axis stage and a second guide rib is formed in the other side of the y-axis stage so as to be in parallel to the y-axis shaft; and wherein a y-axis holder is fixed to one side of the support structure, the y-axis holder slidably holding the y-axis shaft, and a first guide rib is formed in the other side of the support structure, the first guide rib being slidably coupled to the second guide rib.

3. The apparatus as claimed in claim 1, wherein the y-axis driver includes a first magnet fixed to either one of the support structure and the y-axis stage; and a first coil fixed to the other one of the support structure and the y-axis stage, the first coil having multiple windings and being disposed within magnetic field of the first magnet, wherein when electric current is applied to the first coil, the first magnet and the first coil interact to generate an electromagnetic force for driving the y-axis stage in the y-direction.

4. The apparatus as claimed in claim 3, wherein the y-axis driver includes a first yoke concentrating magnetic flux from the first magnet towards the first coil and returning magnetic flux passing through the first coil back to the first magnet.

5. The apparatus as claimed in claim 1, wherein an x-axis shaft is fixed in the x-axis direction to one side of the x-axis stage and a fourth guide rib is formed so as to be in parallel to the x-axis shaft; and wherein an x-axis holder is fixed to one side of the y-axis stage, the x-axis holder slidably holding the x-axis shaft, and a third guide rib is formed in the other side of the y-axis stage, the third guide rib being slidably coupled to the fourth guide rib.

6. The apparatus as claimed in claim 1, wherein the x-axis driver includes a second magnet fixed to either one of the support structure and the x-axis stage; and a second coil fixed to the other one of the support structure and the x-axis stage, the second coil having multiple windings and being disposed within magnetic field of the second magnet, wherein when electric current is applied to the second coil, the second magnet and the second coil interact to generate electromagnetic force for driving the x-axis stage in the x-direction.

7. The apparatus as claimed in claim 6, wherein the x-axis driver includes a second yoke concentrating magnetic flux from the second magnet towards the second coil and returning magnetic flux passing through the second coil back to the second magnet.

8. The apparatus as claimed in claim 1, further comprising a first spring member supported on the support structure and for exerting a force for the y-axis stage to be restored into the initial position thereof, and a second spring member supported on the support structure and for exerting a force for the x-axis stage to be restored into the initial position thereof.

9. The apparatus as claimed in claim 8, wherein the first spring member is formed of a first leaf spring that generates a resistant force against movement of the y-axis stage.

10. The apparatus as claimed in claim 9, wherein the first leaf spring includes a pair of parallel leaf first springs that is installed in one of the support structure and the y-axis stage, and a first bracket is fixed to the other one of the support structure and the y-axis stage, the first bracket having a protrusion being inserted between the pair of first leaf springs.

11. The apparatus as claimed in claim 8, wherein the second spring member is formed of a second leaf spring that generates a resistant force against movement of the x-axis stage.

12. The apparatus as claimed in claim 11, wherein the second leaf spring includes a pair of parallel second leaf springs that is installed in one of the support structure and the x-axis stage, and a second bracket is fixed to the other one of the support structure and the x-axis stage, the second bracket having a protrusion being inserted between the pair of second leaf springs.

13. The apparatus as claimed in claim 1, wherein the y-axis stage is disposed at one side of the support structure and the x-axis is disposed at the other side of the support structure.

14. The apparatus as claimed in claim 13, further comprising a first spring member for urging the y-axis stage towards the initial position thereof, and a second spring member for urging the x-axis stage towards the initial position thereof.

15. The apparatus as claimed in claim 14, wherein the first spring member is formed of an angularly bent leaf spring that connects the y-axis stage to the support member, and the second spring member is formed of a straight leaf spring that connects the x-axis stage and the y-axis stage to each other.

16. The apparatus as claimed in claim 14, wherein the first spring member includes a pair of springs that is disposed so as to face each other on the y-axis and the second spring member includes a pair of springs that is disposed so as to face each other on the x-axis.

17. An apparatus for compensating for vibration of an image capturing device, the apparatus comprising:
a stage installed in a support structure by means of a resilient member so as to be movable in a first direction and a second direction, the first and second directions being substantially perpendicular to each other, an image sensor being able to be mounted on the stage;
a first driver for driving the stage in the first direction;
a second driver for driving the stage in the second direction; and
a control unit for controlling the first and second drivers in a way to compensate for the vibration of image capturing device.

18. The apparatus as claimed in claim 17, wherein the resilient member includes multiple wire springs.

19. The apparatus as claimed in claim 18, wherein the resilient member includes at least three wire springs.

20. The apparatus as claimed in claim 17, wherein the first driver is composed of a first coil and a first magnet that are disposed in the support structure and the stage respectively, or vice versa, and the second driver is composed of a second coil and a second magnet that are disposed in the support structure and the stage respectively, or vice versa.

21. A vibration compensator for an image capturing device, the apparatus comprising:
a first stage installed in a support structure by means of a first resilient member so as to be movable in a first direction;
a first driver for driving the first stage along the first direction;
a second stage installed on the first stage by means of a second resilient member so as to be movable in a second direction, an image sensor being able to be mounted on the second stage;
a second driver for driving the second stage along the second direction, the first and second direction being substantially perpendicular to each other; and
a control unit for controlling the first and second drivers in a way to compensate for the vibration of image capturing device.

22. The vibration compensator as claimed in claim 21, wherein the first and second resilient member include a leaf spring.

23. The vibration compensator as claimed in claim 21, wherein the first driver is composed of a first coil and a first magnet that are disposed in the support structure and the first stage respectively, or vice versa, and the second driver is composed of a second coil and a second magnet that are disposed in the support structure and the second stage respectively, or vice versa.
